(19) United States
(12) Patent Application Publication
(10) Pub. No.: US 2010/0307311 A1
(43) Pub. Date: Dec. 9, 2010

(54) PCB CUTTER MODULE WITH DETACHABLE CUTTERS

(75) Inventor: KUO-CHUNG WANG, Siluo Township (TW)

Correspondence Address: KUO-CHUNG WANG, P.O. BOX 108-00403, TAIPEI, 106, omitted

(73) Assignee: Mr. KUO-CHUNG WANG, Siluo Township (TW)

(21) Appl. No.: 12/479,880

(22) Filed: Jun. 8, 2009

(51) Int. Cl. B26D 7/26

(52) U.S. Cl. 83/651

(57) ABSTRACT

A PCB cutter module is disclosed to include a base panel having locating grooves arranged on one side thereof subject to a predetermined layout and mounting through holes arranged along the border, fastening members mounted in the mounting through holes for fastening the base panel to a worktable, positioning devices, for example, permanent magnets or electromagnets mounted in the locating grooves for detachably securing cutters at the base panel for cutting a workpiece, for example, PC board, and supplementary holder blocks selectively attached to the cutters to hold a respective alignment rod for securing the PC board in position for cutting by the cutters accurately.

### BACKGROUND OF THE INVENTION

1. Field of the Invention

The present invention relates to a PCB cutter module for cutting PC boards or the like, and more particularly, to a PCB cutter module with detachable cutters, which facilitates quick arrangement of cutters on a base panel to fit different cutting requirements, and allows quick replacement of any damaged cutter during operation of the manufacturing line.

2. Description of the Related Art

To eliminate the drawbacks of long operation time, complicated processing procedures and low yield rate of conventional manual fabrication, automatic or semi-automatic machine tools are created. The use of automatic or semi-automatic machine tools greatly reduces the processing time and labor and greatly improves the processing efficiency and quality. Further, the use of automatic or semi-automatic machine tools enables mass production of products. Further, different tools may be used for processing substrates for PC boards subject to desired sizes, shapes or specifications. For example, different cutter modules may be used for cutting substrates subject to different cutting requirements for different models. Conventional PCB cutter modules are not satisfactory in function because of the following drawbacks:
1. A conventional PCB cutter module generally comprises a mold plate and a plurality of cutters affixed to the mold plate. When the cutting edge of one cutter is damaged or unsharpened and a replacement is necessary during fabrication, the manufacturing line must be stopped, allowing removal of the PCB cutter module for a replacement. It is not economic to replace the whole assembly of the PCB cutter module when only one cutter or few cutters are damaged.
2. For cutting different board members at different locations for making PC boards of different sizes and specifications, different PCB cutter modules shall be used. However, it is not economic to use different PCB cutter modules for cutting different board members for making PC boards of different sizes and specifications.
3. When a PCB cutter module is not used, the cutters are kept affixed to the mold plate. During delivering or storing the PCB cutter module, the person handling the PCB cutter module may be injured by the cutters accidentally, or external objects may be scratched or cut by the cutters accidentally.

Accordingly, there is a need for PCB cutter module that eliminates the aforesaid problems and allows quick replacement of the cutters individually.

### SUMMARY OF THE INVENTION

The present invention has been accomplished under the circumstances in view. It is one object of the present invention to provide a PCB cutter module, which allows quick replacement of the cutters individually during PCB fabrication. It is another object of the present invention to provide a PCB cutter module, which storage of the cutters separately, avoiding accidental injury. It is still another object of the present invention to provide a PCB cutter module, which facilitates PC board fabrication and effectively reduces PC board manufacturing costs.

To achieve these and other objects of the present invention, a PCB cutter module comprises a base panel having locating grooves, a plurality of cutters for mounting on the base panel for cutting a workpiece, a plurality of positioning devices respectively provided at the locating grooves of the base panel for securing the cutters to the base panel, and supplementary holder blocks selectively attached to the cutters to hold a respective alignment rod for holding the workpiece in position for cutting by the cutters accurately. By means of the positioning devices, the cutters are respectively detachably secured to the base panel at selected locations. Therefore, when one cutter is damaged, the damaged cutter can be replaced with a new cutter without stopping the manufacturing line.

Further, mounting means is provided at the base panel along each border side to facilitate mounting of the base panel on a worktable. In one example of the present invention, the mounting means comprises a plurality of mounting through holes arranged along each border side of the base panel, and a plurality of fastening members respectively mounted in the mounting through holes to affix the base panel to a worktable.

Based on the aforesaid structural design, two base panels can be fastened to two worktables in a processing machine at different elevations to hold cutters at top and bottom sides of the workpiece subject to a predetermined layout, enabling the workpiece to be accurately cut by the cutters. By means of the aforesaid arrangement, the cutters can be separated from the base panel for delivery or storage separately, assuring high level of safety.

### BRIEF DESCRIPTION OF THE DRAWINGS

FIG. 1 is an exploded view of a PCB cutter module in accordance with the present invention.

FIG. 2 is an exploded view in an enlarged scale of a part of the present invention, showing the structure of the cutter.

FIG. 3 is a schematic drawing of the present invention, showing installation of the PCB cutter module in a processing machine.

FIG. 4 is a schematic drawing of the present invention, showing the workpiece attached to the alignment rods at the base panel on the bottom-sided worktable.

FIG. 5 corresponds to FIG. 4, showing the locating blocks top-sided worktable fastened to the alignment rods at the locating blocks of the bottom-sided worktable.

### DETAILED DESCRIPTION OF THE PREFERRED EMBODIMENT

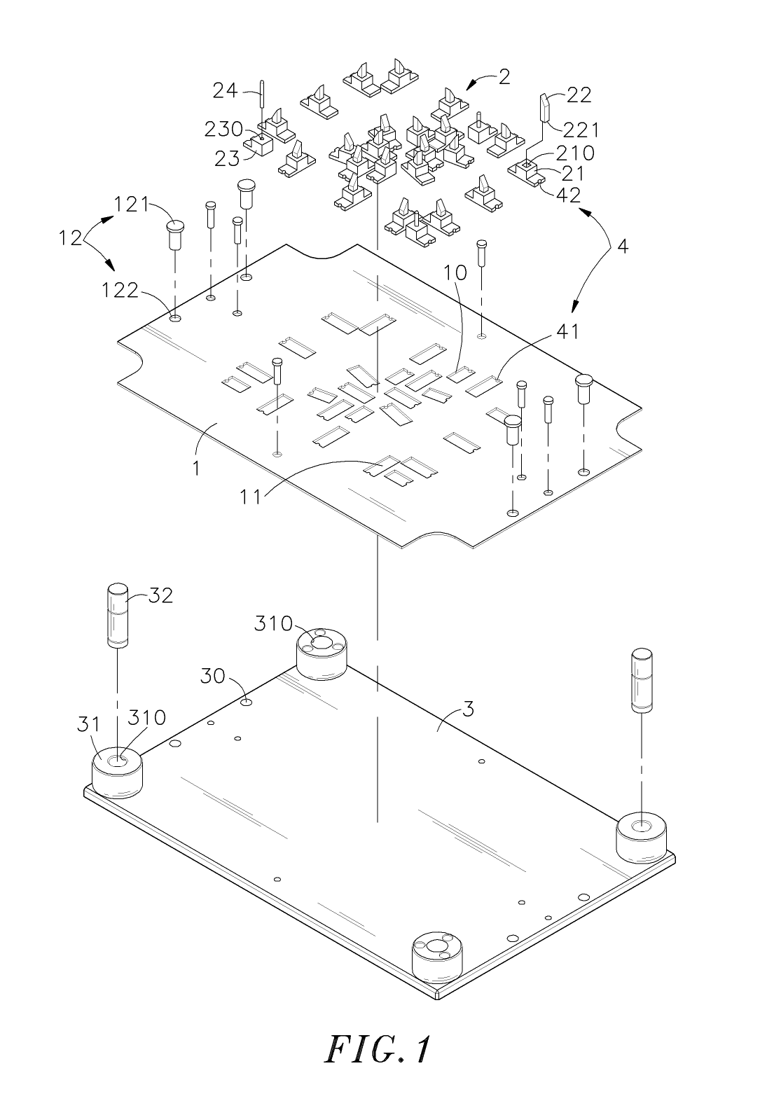

Referring to FIGS. 1˜3, a PCB cutter module in accordance with the present invention is shown comprising at least one base panel 1, a plurality of cutters 2 and at least one worktable 3.

The base panel 1 has a plurality of locating grooves 10 disposed at one side thereof, a plurality of positioning devices 11 arranged in the locating grooves 10, and a plurality of mounting means 12 arranged along the border.

Each cutter 2 comprises a holder block 21 that has a locating hole 210 formed in the upwardly protruded middle part thereof, and a cutter element 22 that has a base portion 221 fastened to the locating hole 210 of the holder block 21 and a cutting edge 222 disposed at the top side. After installation of the respective cutter elements 22 in the respective holder blocks 21, the cutting edges 222 of the cutter elements 22 extend in different directions as designed. Further, L-shaped supplementary holder blocks 23 are selectively arranged relative to the holder blocks 21 of the cutters 2 to hold a respective alignment rod 24. Each L-shaped supplementary holder block 23 has a locating hole 230 located on the topmost edge for the mounting of the associating alignment rod 24.

During installation of the PCB cutter module, the holder blocks 21 of the cutters 2 and the L-shaped supplementary holder blocks 23 are respectively set in the locating grooves 10 of the base panel 1 and secured thereto by the positioning devices 11 in the locating grooves 10, and then the base panel 1 is mounted on the worktable 3 and affixed thereto by the mounting means 12. Each mounting means 12 comprises a mounting through hole 122 respectively aimed at a respective mounting through hole 30 on the worktable 3, and a fastening member 121 fastened to the mounting through hole 122 and the mounting through hole 30 to affix the base panel 1 to the worktable 3.

Further, the aforesaid positioning devices 11 can be magnetic members, either permanent magnets or electromagnets respectively mounted in the locating grooves 10 for securing the holder blocks 21 and the L-shaped supplementary holder blocks 23 by means of magnetic attraction. Alternatively, the positioning devices 11 can be an adhesive for bonding the holder blocks 21 and the L-shaped supplementary holder blocks 23 to the locating grooves 10. Further, the mounting through hole 122 of each mounting means 12 can be a pin hole or screw hole, and the fastening member 121 of each mounting means 12 can be a pin or screw. Clamps may be used as substitutes for affixing the base panel 1 to the worktable 3. Further, a mortise and tenon joint, screw joint, tongue and groove joint or any of suitable fastening means may be employed to affix the holder block 21 or L-shaped supplementary holder block 23 to the associating locating groove 10.

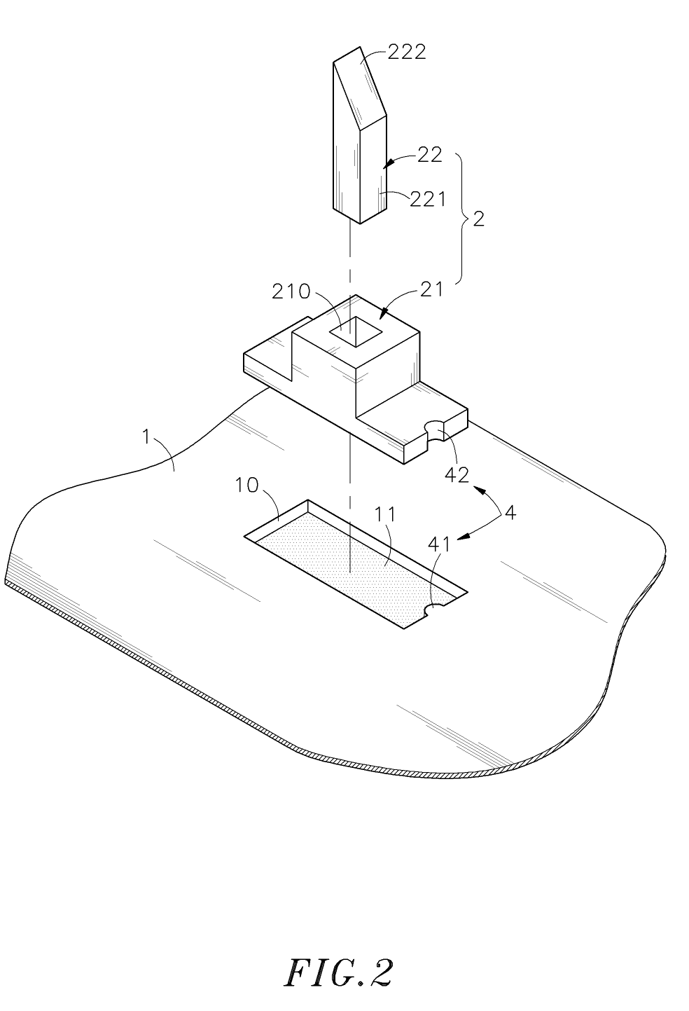

Further, position limit means 4 may be provided between each holder block 21 of each cutter 2 and the associating locating groove 10 to prohibit displacement of the holder block 21 relative to the associating locating groove 10. The position limit means 4 comprises a protrusion 41 protruded from one side of the peripheral wall of the locating groove 10, and a locating notch 42 located on one side of the holder block 21 for engagement with the protrusion 41 (see FIG. 2). Alternatively, the protrusion 41 and the locating notch 42 can be respectively formed in the holder block 21 and the peripheral wall of the locating groove 10, achieving the same effect. Further, a mortise and a tenon, or a toothed portion and a grooved portion may be used to substitute for the arrangement of the protrusion 41 and the locating notch 42, achieving the same effect.

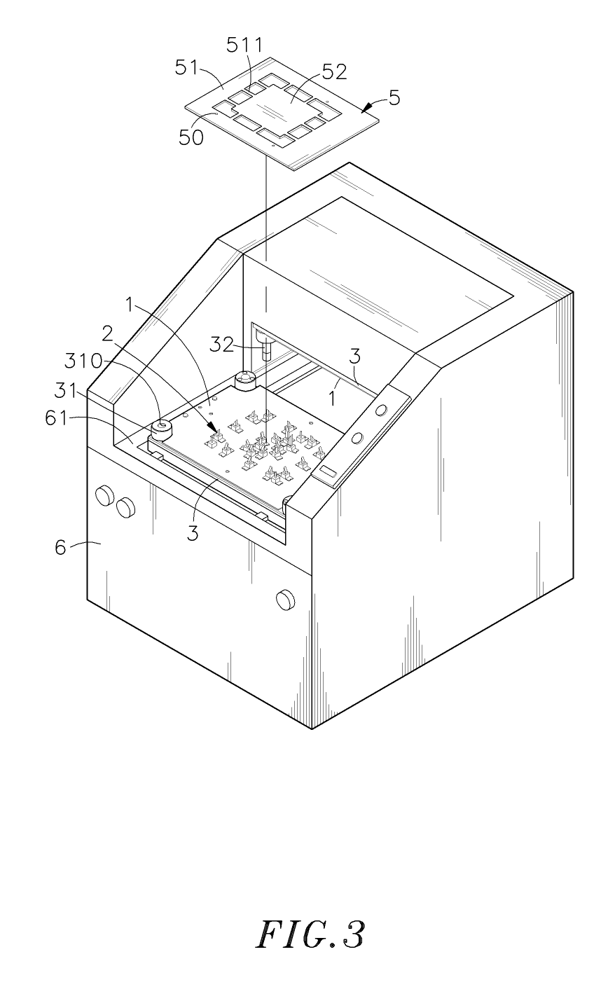

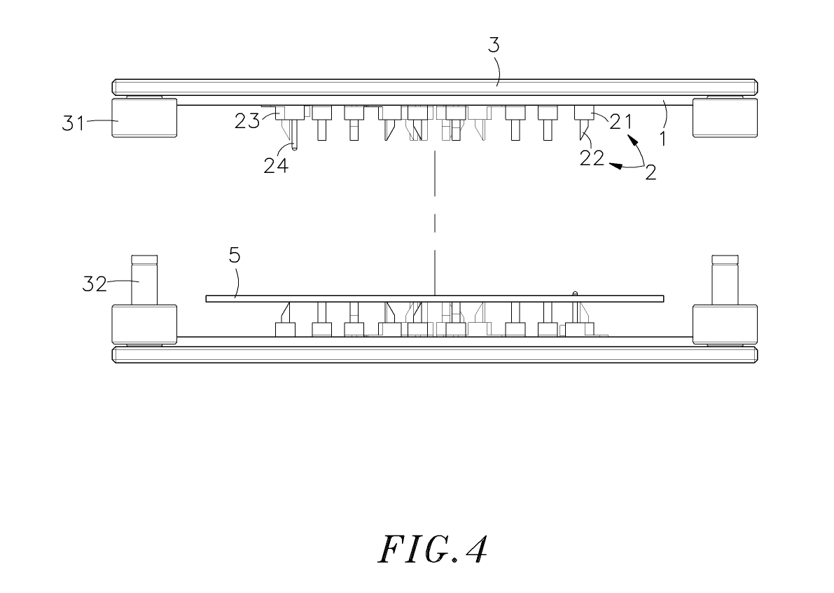

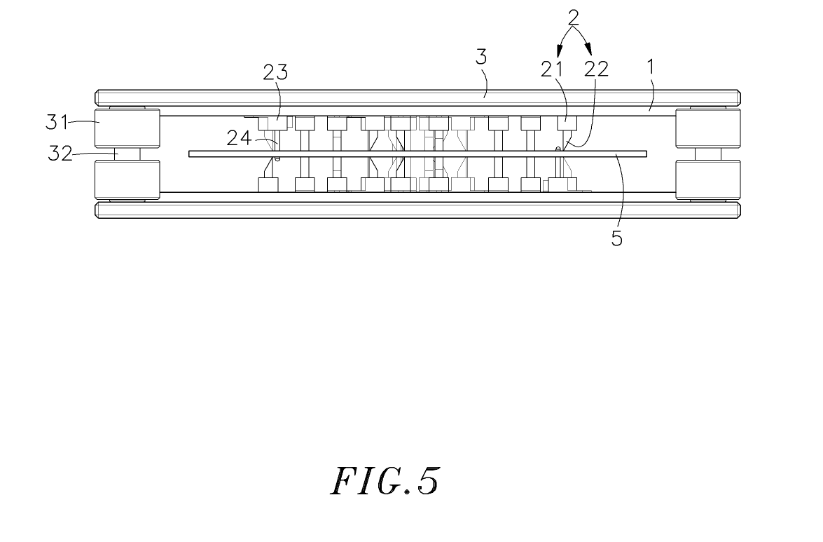

Referring to FIGS. 4 and 5 and FIGS. 1 and 3 again, the arrangement of the locating grooves 10 at the base panel 1 corresponds to the locations at the workpiece (PC board or substrate) 5 to be cut. Therefore, the size, specification and type of the base panel 1 are determined subject to the size, specification and type of the workpiece 5, and, the locating grooves 10 are formed at the base panel 1 subject to determined locations and dimensions for the mounting of the cutters 2. Subject to the aforesaid design, the cutters 2 can be mounted in or dismounted from the locating grooves 10 conveniently. If the cutting edge of one cutter 2 is damaged, the operator can rapidly replace the damaged cutter with a new one without stopping the operation of the manufacturing line. Because the cutters 2 of the PCB cutter module are individually replaceable, it is not necessary to replace the whole cutter module with a new cutter module when one or a number of the cutters 2 are damaged. Further, different sizes or types of base panels 1 that have a different layout of locating grooves 10 may be selectively provided for the installation of the cutters 2 to fit different cutting requirements. Therefore, the invention fits different product designs and saves much the cost.

In one application example of the present invention, the PCB cutter module is formed of two worktables 3 that face each other and are kept apart at a distance, two base panels 1 respectively fastened to the two worktables 3, and a plurality of cutters 2 respectively installed in the locating grooves 10 of the base panels 1 and secured thereto by the respective positioning devices 11. Further, each worktable 3 has a plurality of locating blocks 31 respectively disposed in the corners thereof. Each locating block 31 has a locating hole 310. Further, alignment rods 32 are respectively fastened to the locating holes 310 of the locating blocks 31 to join the two worktables 3. Thus, the cutters 2 at the top-sided base panel 1 are kept in accurate alignment with the respective cutters 2 at the bottom-sided base panel 1, and therefore no any further alignment calibration is necessary. After installation of the PCB cutter module in the worktable 61 of a processing machine 6, the workpiece (PC board or substrate) 5 is set between the cutters 2 at the bottom-sided base panel 1 and the cutters 2 at the top-sided base panel 1 where the holes 50 in the waste material area 51 of the workpiece (PC board or substrate) 5 are respectively coupled to the alignment rods 24. The processing machine 6 can then be operated, enabling the connection portions 511 that are connected between the center part 52 and the border waste material area 51 to be cut off by the respective cutters 22, and therefore the center part 52, i.e., the finished product is separated from the border waste material area 51.

As stated above, the PCB cutter module comprises two worktables 3 that face each other and are kept apart at a distance, two base panels 1 respectively fastened to the two worktables 3, and a plurality of cutters 2 respectively installed in the locating grooves 10 of the base panels 1 and secured thereto by the respective positioning devices 11. During application, the PCB cutter module is installed in the worktable 61 of the processing machine 6 for cutting the workpiece (PC board or substrate) 5. By means of the arrangement of the locating grooves 10 at one side of each base panel 1 subject to a predetermined layout and the use of the positioning devices 11 in the locating grooves 10, the cutters 2 can be conveniently replaceably installed in the base panels 1.

In conclusion, the invention provides a PCB cutter module, which has the following advantages and features:

1. The PCB cutter module comprises at least one base panel 1, a plurality of cutters 2 and at least one worktable 3. The base panel 1 has the characteristics of ease of fabrication and low manufacturing cost. Different sizes or types of base panels 1 that have a different layout of locating grooves 10 may be selectively provided for the installation of the cutters 2 to fit different cutting requirements for cutting different PC boards 5, thereby saving much the processing cost.

2. By means of the arrangement of the locating grooves 10 at one side of each base panel 1 subject to a predetermined layout and the use of the positioning devices 11 in the locating grooves 10, the installation of the cutters 2 is easy. Further, when the cutting edge 222 of the cutter element 22 of one cutter 2 is damaged, the damaged cutter 2 can be separately replaced with a new cutter without throwing away the whole PCB cutter module, thereby saving much labor and cost.

3. When the PCB cutter module is not used, the cutters 2 can be removed from each base panel 1, and the cutters 2 and the base panels 1 can be carried away for storage separately, avoiding accidental cutting injury or cutting edge damage and prolonging the work life of the cutters 2.

Therefore, the scope of the present invention is the detachable mounting arrangement between the base panel and the cutters. By means of the arrangement of the positioning means at the base panel to detachably secure the cutters and the arrangement of the position limit means to prohibit displacement of the cutters relative to the base panel after fastening of the cutters to the base panel by the positioning means, any damaged cutter can be replaced with a new one conveniently and directly, saving much cutter replacement time and labor. Further, multiple base panels that have a different layout of locating grooves can be selectively used for the mounting of the positioning devices to secure the cutters for cutting different PC boards.

The present disclosure thus described with reference to the preferred embodiment, it will be obvious that various modifications, changes and enhancements may be made therein without departing from the spirit and scope of the present disclosure as defined in the disclosure and the claims.

What the invention claimed is:

1. A PCB cutter module, comprising:
a base panel;
mounting means provided at said base panel along each border side of said base panel for mounting;
a plurality of cutters for mounting on said base panel for cutting a workpiece, each said cutter comprising a holder block for mounting on said base panel and a cutter element fastened to said holder block for cutting a workpiece; and
a plurality of positioning devices for securing the holder blocks of said cutters to said base panel at selected locations.

2. The PCB cutter module as claimed in claim 1, wherein said mounting means comprises a plurality of pin holes formed in said base panel, and a plurality of pins respectively mounted in said pin holes to fasten said base panel to a worktable.

3. The PCB cutter module as claimed in claim 1, wherein said mounting means comprises a plurality of screw holes formed in said base panel, and a plurality of screws respectively mounted in said screw holes to fasten said base panel to a worktable.

4. The PCB cutter module as claimed in claim 1, wherein said mounting means comprises a plurality of clamps respectively provided at said base panel for securing said base panel to a worktable.

5. The PCB cutter module as claimed in claim 1, wherein said base panel has a plurality of locating grooves arranged at one side thereof subject to a predetermined layout; said positioning devices are respectively mounted in the locating grooves of said base panel for securing said cutters.

6. The PCB cutter module as claimed in claim 5, further comprising position limit means provided between said locating grooves of said base panel and the holder blocks of said cutters to prohibit displacement of said cutters relative to said base panel.

7. The PCB cutter module as claimed in claim 6, wherein said position limit means comprises a plurality of protrusions formed integral with said base panel and respectively projecting in said locating grooves, and a locating notch located on one side of the holder block of each of said cutters for engagement with the protrusion in each of said locating grooves.

8. The PCB cutter module as claimed in claim 6, wherein said position limit means comprises a plurality of protrusions respectively protruded from one side of the holder block of each of said cutters, and a plurality of locating notches formed on said base panel and respectively disposed at one side of each of said locating grooves for engagement with the protrusions at the holder blocks of said cutters.

9. The PCB cutter module as claimed in claim 6, wherein said positioning devices are magnetic members respectively mounted in said locating grooves for securing the holder blocks of said cutters by means of magnetic attraction.

10. The PCB cutter module as claimed in claim 9, wherein said magnetic members are permanent magnets.

11. The PCB cutter module as claimed in claim 9, wherein said magnetic members are electromagnets.

12. The PCB cutter module as claimed in claim 6, wherein each said positioning device comprises a male fastening member provided at one said locating groove and a female fastening member provided at the holder block of one said cutter and connectable to said male fastening member.

13. The PCB cutter module as claimed in claim 6, wherein each said positioning device comprises a female fastening member provided at one said locating groove and a male fastening member provided at the holder block of one said cutter and connectable to said female fastening member.

14. The PCB cutter module as claimed in claim 1, wherein the holder block of each said cutter has a locating hole formed in an upwardly protruded middle part thereof for the mounting of the associating cutter element.

15. The PCB cutter module as claimed in claim 1, further comprising a plurality of L-shaped supplementary holder blocks selectively attached to the holder blocks of said cutters, each said L-shaped supplementary holder block having a locating hole located on the topmost edge thereof, and a plurality of alignment rods respectively fastened to the locating holes of said L-shaped supplementary holder blocks for holding a workpiece in position for cutting by said cutters.
